(19) United States
(12) Patent Application Publication
(10) Pub. No.: US 2014/0290501 A1
(43) Pub. Date: Oct. 2, 2014

(54) Swizzle System

(71) Applicants: Tariq Farid, North Haven, CT (US); Kamran Farid, North Haven, CT (US); Cynthia Mockler, Chesire, CT (US)

(72) Inventors: Tariq Farid, North Haven, CT (US); Kamran Farid, North Haven, CT (US); Cynthia Mockler, Chesire, CT (US)

(21) Appl. No.: 14/067,941

(22) Filed: Oct. 30, 2013

Related U.S. Application Data
(60) Provisional application No. 61/719,953, filed on Oct. 30, 2012.

(51) Int. Cl. A23P 1/08; A47J 41/00

(52) U.S. Cl. CPC A23P 1/085; A47J 41/005
USPC 99/483

(57) ABSTRACT

A system for dispensing a glaze consisting of a base unit having a vat for storing a liquid which may be heated. A crock having a housing including a bottom wall, side wall and a lid for sealing an interior of the crock. A squeezable semi-rigid bottle for storing a glazing substance. A bottle lid having a nozzle having a glazing outlet enabling glaze contained within said semi-rigid bottle to be dispensed when said semi-rigid bottle has a force applied to it thereby forcing the glaze through the nozzle and wherein the semi-rigid bottle is positioned within said crock enabling glaze stored within said bottle to maintain a liquid state for dispensing.

### TECHNICAL FIELD OF THE INVENTION

The present invention relates in general to food processing, and in particular to a swizzle dispensing system.

### BACKGROUND OF THE INVENTION

The application of glaze onto a product provides a unique appearance and also provides an opportunity to provide a different taste to an underlying product. While there are known techniques to provide a swizzled glazed product, such techniques are more inclined for individual presentations. For instance, swizzle techniques have been employed in the past utilizing three basic components including a liquid glaze or coating contained within a squeezable or pliable bag which has an outlet port which feeds into a tip. The bag is squeezed and the glaze is projected through the tip and positioned onto the desired substrate. Such technique is readily used in cakes and is called “Piping”. Piping is utilized to enhance the decorative designs of the underlying substrate such as a cake or cupcake. Very ornate designs may be produced by the artisan's skills and piping tips. However, piping is a very unique skill and not all individuals may produce the same result. For instance, in a very popular television show Cake Boss with Buddy Valastro, contestants are required to pipe different cakes and judged on quality. As may be appreciated, various results are achieved depending on the skill of the artisan.

### SUMMARY OF THE INVENTION

A system for dispensing a glaze consisting of a base unit having a vat for storing a liquid which may be heated. A crock having a housing including a bottom wall, side wall and a lid for sealing an interior of the crock. A squeezable semi-rigid bottle for storing a glazing substance. A bottle lid having a nozzle having a glazing outlet enabling glaze contained within said semi-rigid bottle to be dispensed when said semi-rigid bottle has a force applied to it thereby forcing the glaze through the nozzle and wherein the semi-rigid bottle is positioned within said crock enabling glaze stored within said bottle to maintain a liquid state for dispensing.

### DESCRIPTION OF THE DRAWINGS

For a more complete understanding of the present invention and the advantages thereof, reference is now made to the following description taken in conjunction with the accompanying Drawings.

FIG. 1 is a perspective view illustrating the components of the system including a Swizzle crock, swizzle bottles and swizzle tips.

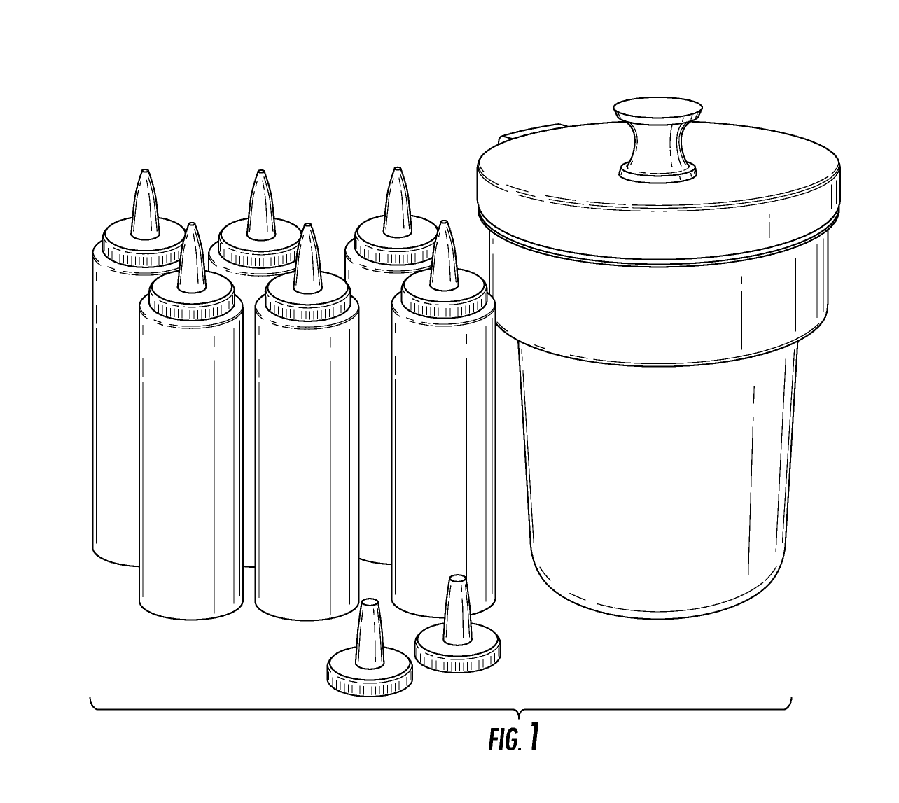

FIG. 2. is a perspective view illustrating the swizzle bottles inside a swizzle crock inside a swizzle warming insert according to an embodiment of the invention.

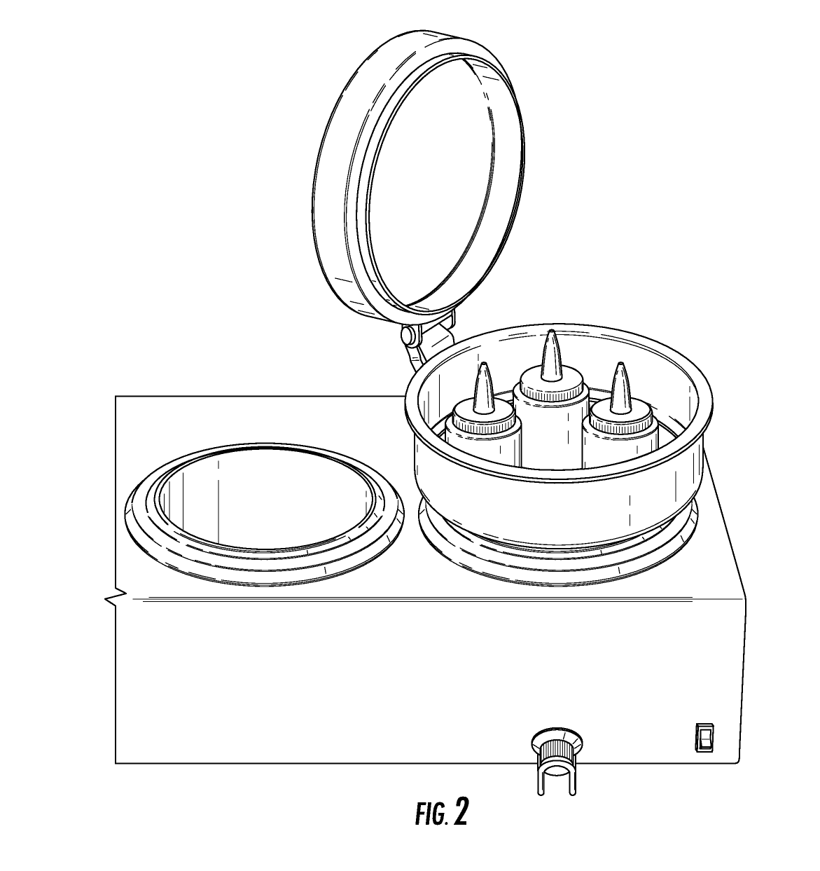

FIG. 3 is a perspective view of the swizzle bottle in the swizzle crock with the lid opened and also with the lid closed according to an embodiment of the invention.

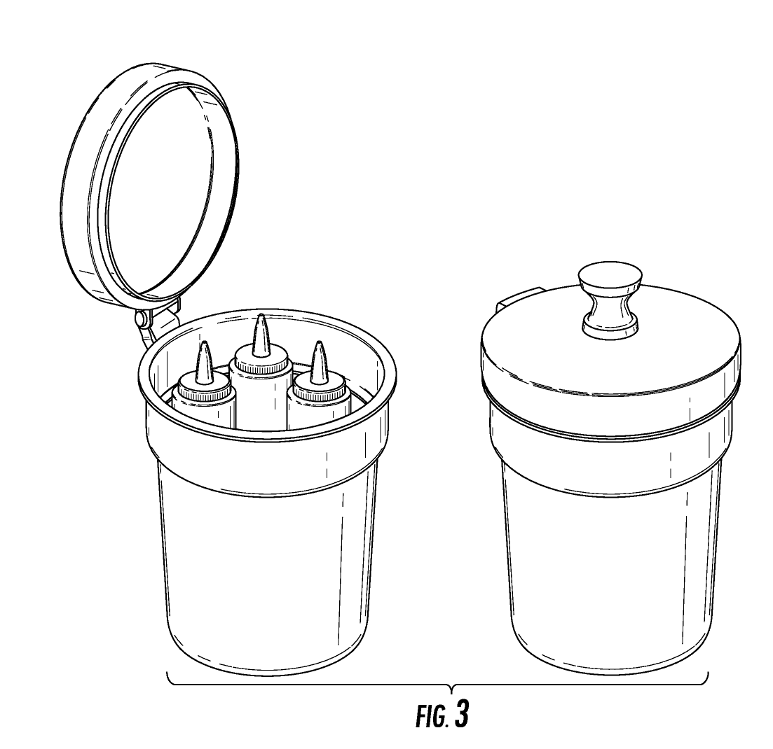

FIG. 3a illustrates the swizzle tip dispensing a thin line of swizzle according to an embodiment of the invention.

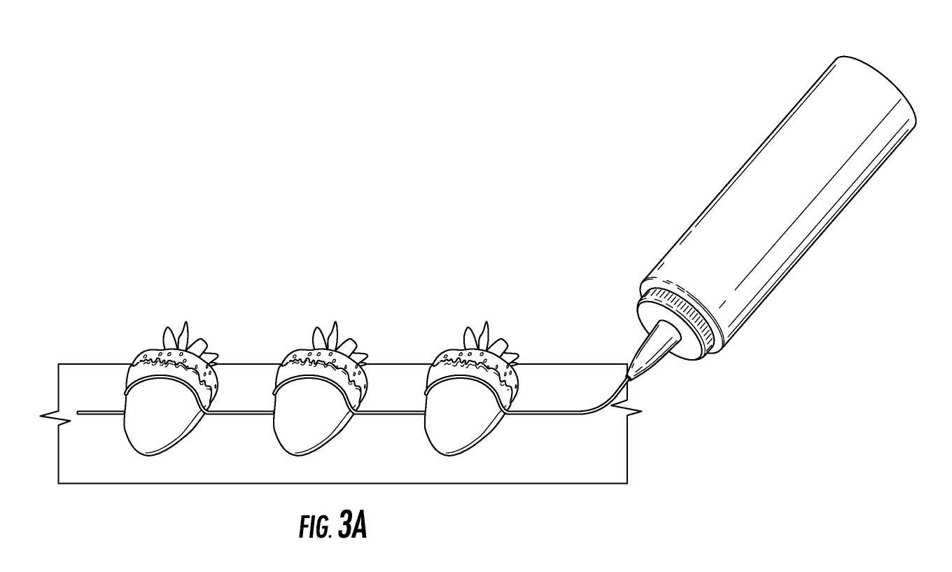

FIG. 4 is a perspective view illustrates the melting glaze in a swizzle bottle in a solid condition and inserted into a swizzle crock for melting.

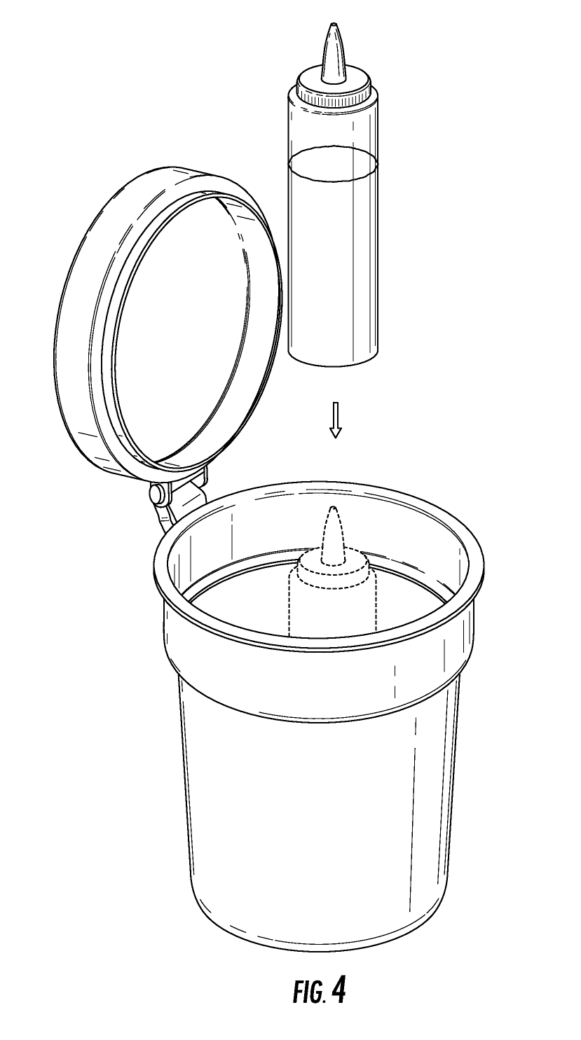

FIG. 5 is a perspective view of the swizzle-bottle with the custom tip.

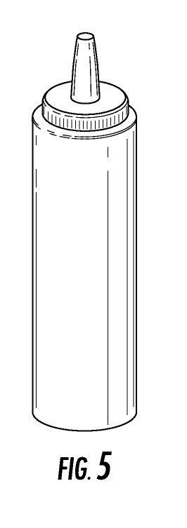

FIG. 6 illustrates swizzle on fruit product being dispensed utilizing the components of the present invention.

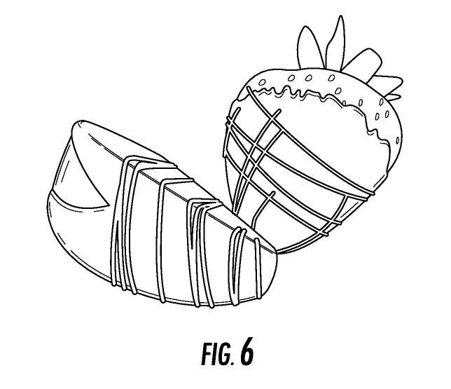

### DETAILED DESCRIPTION OF THE INVENTION

The invented new system for the processing and placement of decorative coatings known as swizzles onto a fruit specimen. These decorative coatings consist of thin stripes of a preferred coating material such as white chocolate onto a coated or uncoated fruit specimen to provide an ornate and decorative appearance.

The Swizzle System is described in the attached drawings. In general, the Swizzle system includes multiple components which work in conjunction for achieving the result of providing for an easy to use swizzle system which provides exceptional results by utilizing components which provide consistent operational properties for maintaining quality throughout an entire franchise network.

The inventors of the Swizzle System are affiliated with the very successful business Edible Arrangements. Edible Arrangements utilize fruit specimens for creating ornate fruit arrangements and tasteful “finger foods”. Many fruit specimens are coated in chocolate or other tantalizing coatings which enhance the underlying fruit's natural tastes. The success of the business has resulted in numerous franchises being established in the United States and in foreign countries. With this success come management challenges in maintaining the integrity and consistency of the products offered. However, as noted, as with piping, the application of swizzles onto a product utilizing prior art systems encourages variations due to the skill of the artisan and the operational conditions which the operator is operating under. For instance, the operator may apply to much pressure onto the glazing bag resulting in too much glaze being applied. Or, the operator may be holding the tip at an awkward angle resulting in an inconsistent pattern. Or, the glaze may be too hot, or too cold resulting in an inconsistent mixture being applied. All of these factors provide for inconsistent results.

Accordingly, there is a need for a simple to use system which removes a lot of operator variability for maintaining consistent operational conditions enhancing the quality of the applied swizzle.

The invention includes multiple components which work in conjunction to provide an efficient and easy to use system for imparting decorative glazing onto fruit.

In particular, a heating element which is standard and provided by Server is utilized. Such heating elements include a base unit which is filled with water and heated to a desired temperature for maintaining chocolate in a heated state. The heating element is a standard feature in Edible Arrangement stores as they are routinely utilized for heating chocolate. By utilizing common components, the franchisees are able to minimize capital expenditure costs. The heating element or base unit contains a vat for receiving water for heating. A Swizzle crock is positioned within the vat housing the water. The Swizzle Crock has a solid cover and preferably a hinged lid. The lid is intended for being closed at all times. No water is used in the swizzle crock, the only water is contained in the base server or heating unit. The Swizzle Crock with lid is shown in the attached drawings. In the preferred embodiment the swizzle crock is the same size as a standard crock utilized in the Server heating element which is used to melt chocolate and the like for the dipping of fruit. By utilizing similar shaped crocks, the standard Server heating elopement may be used. Hence a system exists for the creation of a central coating station wherein a first and second crock is presented adjacently with the first crock being used to heat chocolate and the second crock for warming glazed elements. By utilizing a single heating element, space is saved and a central coating station is created.

The swizzle crock has an interior for receiving swizzle bottles. The swizzle bottles are preferably provided by Table Craft and are known as tablecraft 112C-1 squeeze bottles which are clear plastic squeeze bottles and typically have a twelve oz capacity. The clear bottle allows the user to quickly identify the product inside the bottle. For instance, dark chocolate may be in one bottle and white chocolate in another. The bottles are comprised of polyethylene plastic providing for a resistant flexible housing which is not too stiff or too flexible but requires a firm constant pressure for squeezing. Thus, unlike a flimsy piping bag, the polyethylene plastic has a fixed shape and a consistent deformation pressure.

The Tablecraft bottles are enclosed utilizing swizzle tips which include specially designed swizzle nozzles enabling glaze to be dispensed from the bottle in a smooth and thin manner. The nozzles are designed such that the dispensed chocolate having a known melting consistency is dispensed at a constant volume when the desired pressure is applied to the bottle. By having a special nozzle design with the standard bottle, varying franchisees can dispense the chocolate swizzle concisely throughout the franchises. The nozzle presents a constant swizzle bead. Preferably the bottles and the interior of the Swizzle crock are sized so a plurality and preferably three swizzle bottles fit within the swizzle crock. In operation a variety of swizzle nozzles may be utilized of differing shapes and widths providing for an assortment of swizzles to be dispensed onto the fruit arrangements.

In operation the glaze can be melted in the swizzle bottle. The desired amount of glaze is added to the bottle and the tip is then attached to the bottle. The entire swizzle bottle and lid are positioned in the swizzle crock and the lid is closed. In takes approximately one hour to melt the glaze.

In the preferred embodiment the server unit is set at 110 degrees with just enough water to have the swizzle crock stay steady when the lid is open. The swizzle bottles with the respective glazes are positioned in the swizzle crock and the lid is closed. The glaze is melted inside the bottles and the dry air within the crock enables the glaze to maintain its inherent characteristics and properties with no moisture inside the crock. With the utilization of the bottles and swizzle tips, the interior of the bottles are open to the ambient environment. Accordingly, it is important that no moisture is inside the swizzle crock as the moisture will ruin the glaze materials. The lid of the crock is closed at all times to prevent moisture from entering into the crock.

By utilizing squeeze bottles which have a semi-rigid structure which enables them to be free standing, resistance is provided to the operator such that the glaze will not exit the bottle without sufficient force being applied. Unlike a non-rigid flexible bag which can accidently be collapsed resulting in a large amount of glaze being dispensed unintentionally as no resistance is supplied; utilizing the bottles prevents the accidental dispensing. Additionally, by utilizing a common bottle with a consistent resistance, the operator quickly realizes how much force is needed in squeezing the bottle to achieve the desired dispensing quantity. Also, by utilizing the special tips and the swizzle crock, the glaze is maintained at a consistent consistency and viscosity producing known results.

Although the preferred embodiment has been described in detail, it should be understood that various changes, substitutions and alterations can be made therein without departing from the spirit and scope of the invention as defined by the appended claims.

We claim:

1. A system for dispensing a glaze consisting of:
a base unit having a vat for storing a liquid which may be heated;
a crock having a housing including a bottom wall, side wall and a lid for sealing an interior of the crock;
a squeezable semi-rigid bottle for storing a glazing substance;
a bottle lid having a nozzle having a glazing outlet enabling glaze contained within said semi-rigid bottle to be dispensed when said semi-rigid bottle has a force applied to it thereby forcing the glaze through said nozzle and
wherein said semi-rigid bottle is positioned within said crock enabling glaze stored within said bottle to maintain a liquid state for dispensing.
